(19) United States
(12) Patent Application Publication
(10) Pub. No.: US 2026/0128369 A1
(43) Pub. Date: May 7, 2026

(54) SOLID ELECTROLYTE, METHOD FOR MANUFACTURING THE SAME, AND BATTERY

(71) Applicant: Tsinghua Shenzhen International Graduate School, Shenzhen (CN)

(72) Inventors: YAN-BING HE, Shenzhen (CN); Jin-Shuo Mi, Shenzhen (CN); Ting-Zheng Hou, Shenzhen (CN); Ming Liu, Shenzhen (CN); Ke Yang, Shenzhen (CN); Jia-Bin Ma, Shenzhen (CN); Li-Kun Chen, Shenzhen (CN); Jie Biao, Shenzhen (CN); Cui-Cui Wang, Shenzhen (CN); Fei-Yu Kang, Shenzhen (CN)

(21) Appl. No.: 19/437,607

(22) Filed: Dec. 31, 2025

Related U.S. Application Data
(63) Continuation-in-part of application No. PCT/CN2023/124074, filed on Oct. 11, 2023.

(30) Foreign Application Priority Data
Sep. 22, 2023 (CN) 202311086352.9

(51) Int. Cl. H01M 10/0562; H01M 10/0525

(52) U.S. Cl. CPC H01M 10/0562; H01M 10/0525; H01M 2300/0068

(57) ABSTRACT

A solid electrolyte, a method for manufacturing the solid electrolyte, and a battery are disclosed. The solid electrolyte includes a polymer, a silver salt, and an alkali metal salt. When the solid electrolyte provided in the present disclosure is matched with a metal such as lithium metal, a gradient SEI layer rich in inorganic components can be in-situ generated during electrochemical cycling. The gradient SEI layer includes an outer layer rich in silver-containing inorganic components and an inner layer rich in lithium-containing inorganic components. Thus, the battery possesses high ionic conductivity and stability against the lithium metal anode, and the in-situ constructed SEI layer can uniformize lithium ion deposition, inhibit lithium dendrite growth, realize stable cycling under high current, and exhibit excellent low-temperature electrochemical performance.

### CROSS-REFERENCE TO RELATED APPLICATION(S)

The present application claims the benefit and priority to Chinese Patent Application Serial No. 202311086352.9, filed on Sep. 22, 2023, in China National Intellectual Property Administration, and the content of which is hereby fully incorporated by reference into the present application.

### FIELD

The subject matter herein generally relates to a solid electrolyte, a method for manufacturing the same, and a battery.

### BACKGROUND

Lithium-ion batteries (LIBs) exhibit numerous advantages, including low self-discharge rate, absence of memory effect, high energy density, and long cycle life, thereby enabling their widespread adoption in consumer electronics, energy storage, new energy, and other fields. Currently, lithium metal is recognized as a highly promising anode material for high-energy lithium batteries. However, liquid lithium-ion batteries suffer from severe issues such as intense interfacial reactions and inadequate safety performance. Theoretically, solid lithium-ion batteries (SSLIBs) featuring high energy density and superior safety represent the most promising alternatives to liquid lithium-ion batteries.

Nevertheless, during electrochemical cycling of a lithium metal battery assembled with a solid polymer electrolyte (SPE), a solid electrolyte interface (SEI) formed on a side close to the lithium metal undergoes repeated fracture and reconstruction, accompanied by severe lithium dendrite growth. In particular, short circuits are prone to occur under high current densities, posing a significant barrier to achieving high-flux operation.

### BRIEF DESCRIPTION OF THE DRAWINGS

Implementations of the present disclosure will now be described, by way of example only, with reference to the attached figures.

FIG. 1 is a flowchart of a method for manufacturing a solid electrolyte according to an embodiment of the present disclosure.

FIG. 2 is a diagrammatic view of a battery according to an embodiment of the present disclosure.

FIG. 3A is a cross-sectional scanning electron microscopy (SEM) image of a PVAL composite solid electrolyte prepared in Preparation Example 1 of the present disclosure.

FIG. 3B is a cross-sectional SEM image of a PVL composite solid electrolyte prepared in Comparative Preparation Example 1 of the present disclosure.

FIG. 3C is a morphological structure of a gradient SEI layer rich in inorganic components formed in a Li—Cu half-cell based on the PVAL composite solid electrolyte membrane (named as PVAL/Li—Cu half-cell) in Example 1 under a cryogenic transmission electron microscope.

FIGS. 4A to 4F are enlarged views of Parts A to F in FIG. 3C, respectively.

FIG. 5 is a morphological structure of the gradient SEI layer shown in FIG. 3C with silver-containing inorganic salts and lithium-containing inorganic salts labeled.

FIG. 6 shows coulombic efficiency test curves of the PVAL/Li—Cu half-cell in Example 1 and a Li—Cu half-cell based on the PVL composite solid electrolyte membrane (named as PVL/Li—Cu half-cell) in Comparative Example 1.

FIG. 7 shows nucleation potential test curves of the PVAL/Li—Cu half-cell in Example 1 and the PVL/Li—Cu half-cell in Comparative Example 1.

FIG. 8 shows cross-sectional SEM images of nucleation of the PVL/Li—Cu half-cell in Comparative Example 1 and nucleation of the PVAL/Li—Cu half-cell in Example 1, respectively.

FIG. 9 shows surface SEM images of nucleation of the PVL/Li—Cu half-cell in Comparative Example 1 and nucleation of the PVAL/Li—Cu half-cell in Example 1, respectively.

FIG. 10 shows a surface SEM image of lithium metal deposition after depositing 1 mAh at 0.5 mA/cm²for a Li—Li symmetric cell based on the PVL composite solid electrolyte membrane (named as PVL/Li—Li symmetric cell) in Comparative Example 1, and surface SEM images of lithium metal deposition after depositing 1 mAh, 10 mAh, and 20 mAh at 0.5 mA/cm² respectively for a Li—Li symmetric cell based on the PVAL composite solid electrolyte membrane (named as PVAL/Li—Li symmetric cell) in Example 1.

FIG. 11 shows cross-sectional SEM images of lithium metal deposition after depositing 5 mAh at 0.5 mA/cm² for the PVL/Li—Li symmetric cell in Comparative Example 1 and the PVAL/Li—Li symmetric cell in Example 1, respectively.

FIG. 12 shows exchange current density test curves of the PVAL/Li—Li symmetric cell in Example 1 and the PVL/Li—Li symmetric cell in Comparative Example 1.

FIG. 13 shows critical current density (CCD) test curves of the PVAL/Li—Li symmetric cell in Example 1 and the PVL/Li—Li symmetric cell in Comparative Example 1.

FIG. 14 shows long-cycle test curves of the PVAL/Li—Li symmetric cell in Example 1 and the PVL/Li—Li symmetric cell in Comparative Example 1 under 10 mA/cm²and 10 mAh/cm², respectively.

FIG. 15 shows impedance test curves of the PVAL/Li—Li symmetric cell in Example 1 before and after cycling, respectively.

FIG. 16 shows XPS test curves of S2p on the lithium metal surface after cycling for the PVAL/Li—Li symmetric cell in Example 1 and the PVL/Li—Li symmetric cell in Comparative Example 1, respectively.

FIG. 17 shows XPS test curves of F1s on the lithium metal surface after cycling for the PVAL/Li—Li symmetric cell in Example 1 and the PVL/Li—Li symmetric cell in Comparative Example 1, respectively.

FIG. 18 shows rate performance test curves of a full cell based on the PVAL composite solid electrolyte membrane (named as PVAL full cell) in Example 1 and a full cell based on the PVL composite solid electrolyte membrane (named as PVL full cell) in Comparative Example 1.

FIG. 19 shows cycle performance test curves of the PVAL full cell in Example 1 and the PVL full cell in Comparative Example 1 at a low temperature of −20° C., respectively.

### DETAILED DESCRIPTION

It will be appreciated that for simplicity and clarity of illustration, where appropriate, reference numerals have been repeated among the different figures to indicate corresponding or analogous elements. In addition, numerous specific details are set forth to provide a thorough understanding of the embodiments described herein. However, it will be understood by those of ordinary skill in the art that the embodiments described herein can be practiced without these specific details. In other instances, methods, procedures, and components have not been described in detail so as not to obscure the related relevant feature being described. Also, the description is not to be considered as limiting the scope of the embodiments described herein. The drawings are not necessarily to scale, and the proportions of certain parts may be exaggerated to illustrate details and features of the present disclosure better. The disclosure is illustrated by way of example and not by way of limitation in the figures of the accompanying drawings, in which like references indicate similar elements. It should be noted that references to “an” or “one” embodiment in this disclosure are not necessarily to the same embodiment, and such references mean “at least one.”

The term “comprising” when utilized, means “including, but not necessarily limited to”; it specifically indicates open-ended inclusion or membership in the so-described combination, group, series, and the like.

The present disclosure provides a solid electrolyte, the solid electrolyte include a polymer, a silver salt, and an alkali metal salt.

Wherein, based on a total mass of the solid electrolyte, a content of the silver salt may be 1.5 wt %˜10 wt %, further 2 wt %˜7 wt %, and further 2 wt %˜5 wt %. Exemplarily, the content of the silver salt may be 1.5 wt %, 2 wt %, 2.5 wt %, 3 wt %, 3.5 wt %, 4 wt %, 4.5 wt %, 5 wt %, 5.5 wt %, 6 wt %, 6.5 wt %, 7 wt %, 8 wt %, 9 wt %, 10 wt %, or a value between any two of the above numerical values. An excessively small content of the silver salt tends to result in uneven formation of an Ag-containing solid electrolyte interphase (SEI), while an excessively large content is liable to degrade the mechanical properties of the solid electrolyte and increase the risk of short circuit. Therefore, by controlling the content of the silver salt within the above range, which can form a more uniform SEI, help improve the mechanical properties of the solid electrolyte, and reduce the risk of short circuit.

In some embodiments, the silver salt is a soluble silver salt, which may include, but is not limited to, at least one of AgNO₃, AgTFSI, and AgClO₃.

In some embodiments, the alkali metal salt may include, but is not limited to, at least one of lithium salts, sodium salts, and potassium salts. The alkali metal salt may be determined according to a type of a battery to which the solid electrolyte is applied. When the solid electrolyte is applied to a lithium-ion battery, a lithium salt may be added. When the solid electrolyte is applied to a sodium-ion battery, a sodium salt may be added.

In some embodiments, the alkali metal salt may be a sulfur-containing alkali metal salt.

A lithium-ion battery to which the solid electrolyte is applied is taken as an example for illustration. The alkali metal salt is lithium salt. In an embodiment, the alkali metal salt is a sulfur-containing lithium salt.

In some embodiments, the sulfur-containing lithium salt may include, but is not limited to, at least one of lithium bis(fluorosulfonyl)imide (LiFSI) and lithium bis(trifluoromethanesulfonyl)imide (LiTFSI).

In some embodiments, based on the total mass of the solid electrolyte, a content of the lithium salt may be 30 wt %˜40 wt %. Exemplarily, the addition amount may be 30 wt %, 31 wt %, 32 wt %, 33 wt %, 34 wt %, 35 wt %, 36 wt %, 37 wt %, 38 wt %, 39 wt %, 40 wt %, or a value between any two of the above numerical values.

In some embodiments, the polymer may include, but is not limited to, at least one of polyethylene oxide (PEO), polyvinylidene fluoride (PVDF), and polyvinylidene fluoride-hexafluoropropylene (PVDF-HFP).

In some embodiments, the solid electrolyte further includes a plurality of ceramic particles. In some embodiments, the ceramic particles may include, but is not limited to, at least one of Li₇La₃Zr₂O₁₂ (LLZO) ceramic particles, Li_{1.3}Al_{0.3}Ti_{1.7}(PO₄)₃ (LATP) ceramic particles, SiO₂ ceramic particles, and Al₂O₃ ceramic particles. In some embodiments, an average particle size of the ceramic particle may be 100 nm˜800 nm, further 100 nm˜500 nm, and further 100 nm˜300 nm. Ceramic particles with smaller particle sizes are more likely to be uniformly dispersed in the solid electrolyte. Adding an appropriate content of ceramic particles can effectively improve the mechanical properties of the solid electrolyte. As the content of the ceramic particles increases, the mechanical properties of the solid electrolyte are improved. Generally, the content of the ceramic particles does not exceed 50 wt % of the total mass of the solid electrolyte.

Referring to FIG. 1, a method for manufacturing the solid electrolyte is provided by way of example, as there are a variety of ways to carry out the method. The method can begin at step 1.

Step 1, a polymer, a silver salt, and a lithium salt are mixed uniformly to obtain a mixed solution.

In some embodiments, the silver salt is a soluble silver salt, which may include, but is not limited to, at least one of AgNO₃, AgTFSI, and AgClO₃.

In some embodiments, based on a total mass of the solid electrolyte, a content of the silver salt may be 1.5 wt %˜10 wt %.

In some embodiments, the alkali metal salt may include, but is not limited to, at least one of lithium salts, sodium salts, and potassium salts.

In some embodiments, the alkali metal salt may be a sulfur-containing alkali metal salt.

In some embodiments, the alkali metal salt is a sulfur-containing lithium salt.

In some embodiments, the sulfur-containing lithium salt may include, but is not limited to, at least one of lithium bis(fluorosulfonyl)imide (LiFSI) and lithium bis(trifluoromethanesulfonyl)imide (LiTFSI).

In some embodiments, based on the total mass of the solid electrolyte, a content of the lithium salt may be 30 wt %˜40 wt %.

In some embodiments, the polymer may include, but is not limited to, at least one of polyethylene oxide (PEO), polyvinylidene fluoride (PVDF), and polyvinylidene fluoride-hexafluoropropylene (PVDF-HFP).

In step 1, a solvent needs to be added to the mixed solution, wherein the solvent may be N, N-dimethylformamide (DMF). The mixed solution with the solvent are stirred at room temperature for more than 2 hours to be mixed uniformly, thereby obtaining the mixed solution.

In some embodiments, ceramic particles may also be added to the mixed solution, and the mixed solution with the ceramic particles is stirred at room temperature for more than 6 hours to mix uniformly.

In some embodiments, the ceramic particles may include, but is not limited to, at least one of Li₇La₃Zr₂O₁₂ (LLZO) ceramic particles, Li_{1.3}Al_{0.3}Ti_{1.7}(PO₄)₃ (LATP) ceramic particles, SiO₂ceramic particles, and Al₂O₃ ceramic particles.

In some embodiments, an average particle size of the ceramic particle may be 100 nm˜800 nm

In some embodiments, a content of the ceramic particles does not exceed 50 wt % based on the total mass of the solid electrolyte

Step 2, the mixed solution is dried and shaped to obtain the solid electrolyte.

In step 2, the mixed solution is transferred to a glass petri dish, and then placed in a blast drying oven to dry and shape at approximately 55° C. to obtain the solid electrolyte. To facilitate subsequent application in a lithium metal battery, the solid electrolyte is in the form of a film. The film is punched into a preset size and stored in a dry state under an inert atmosphere.

A solid electrolyte interphase (SEI) layer will be formed on a surface of the solid electrolyte. A construction method of the SEI layer is as follows: the solid electrolyte is in physical contact with an alkali metal to form a battery, and an in-situ reaction occurs during an electrochemical charge-discharge process of the battery to form the SEI layer. The SEI layer includes alkali metal-containing inorganic salts and silver-containing inorganic salts. Wherein, the alkali metal with a certain shape usually exists in the form of sheets or films.

Lithium metal is taken as an example for illustration. The solid electrolyte is prepared by the method mentioned above, and the obtained solid electrolyte is matched and assembled with lithium metal to form a battery. During physical contact and electrochemical charge-discharge processes, in-situ chemical and electrochemical reactions occur to generate a gradient SEI layer rich in inorganic components.

It is defined that a side of the gradient SEI layer rich in inorganic components adjacent to the alkali metal (such as metallic lithium) is an inner layer, and a side away from the alkali metal is an outer layer. In the gradient SEI layer, a content of the alkali metal-containing inorganic salts (such as lithium-containing inorganic salt) decreases from the inner layer to the outer layer, while a content of the silver-containing inorganic salts increases from the inner layer to the outer layer, thereby forming the gradient SEI layer rich in inorganic components. The inner layer of the gradient SEI layer, which is rich in alkali metal-containing inorganic salts, facilitates the uniform transport of ions (such as lithium ions) in the SEI layer and achieves uniform deposition/stripping of ions (such as lithium ions). The outer layer of the gradient SEI layer, which is rich in silver-containing inorganic salts, benefits from the good ductility of silver-containing inorganic salts, which facilitates the rapid transport of lithium ions and maintains the structural stability of the SEI layer during cycling. In addition, there are almost no silver-containing inorganic salts in the inner layer of the gradient SEI layer, where elemental silver or silver alloys are the main components.

In some embodiments, the alkali metal-containing inorganic salt may be lithium-containing inorganic salt. In some embodiments, the lithium-containing inorganic salts may include, but not limited to, at least one of LiF, Li₃N, and Li₂S. In some embodiments, the silver-containing inorganic salt may include, but not limited to, at least one of Ag₂S and AgF. Various inorganic salt components are generated by the decomposition of cations and anions (such as Li⁺, Ag⁺, NO₃⁻, and FSI⁻) in the electrolyte through a series of chemical reactions on a lithium metal anode.

The methods for constructing the solid electrolyte and the gradient SEI layer provided in the embodiments of the present disclosure are simple, with mild in-situ reaction conditions and low cost, and have strong adaptability and universality. The solid electrolyte and the in-situ constructed gradient SEI layer rich in inorganic components can be applied to a lithium metal battery to improve the stability of the solid electrolyte against lithium metal and the ability to transport lithium ions with high flux.

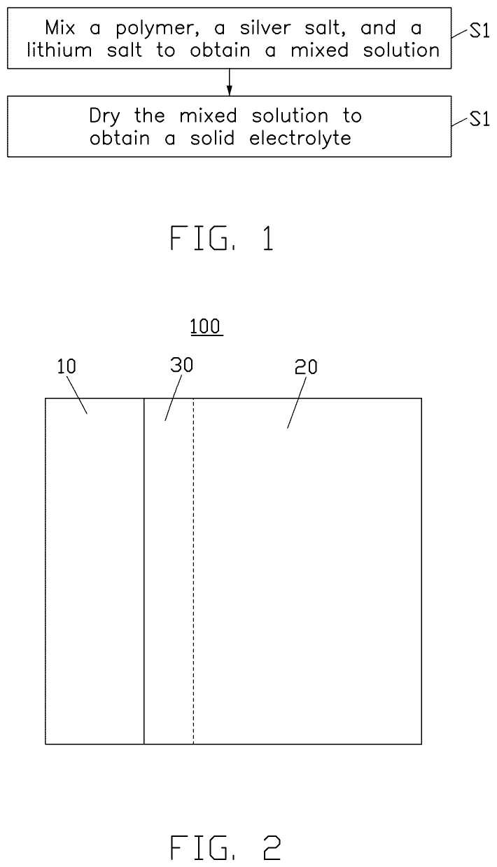

The present disclosure further provides a battery, which includes a metal electrode and the solid electrolyte mentioned above in physical contact with the metal electrode. The SEI layer is formed on a surface of the solid electrolyte contact with the metal electrode. An in-situ reaction occurs between the solid electrolyte and the metal electrode during an electrochemical charge-discharge process to form the SEI layer. Referring to FIG. 2, the battery 100 includes the metal electrode 10 and the solid electrolyte 20 in physical contact with the metal electrode 10. And the SEI layer 30 is formed on the surface of the solid electrolyte 20 contact with the metal electrode 10.

In some embodiments, the metal electrode may be a metal anode, such as a lithium metal anode. When the alkali metal salt in the solid electrolyte is a sodium salt or a potassium salt, the metal electrode may be a sodium metal anode or a potassium metal anode.

A lithium metal battery is taken as an example for illustration. The solid electrolyte mentioned above is matched and assembled with lithium metal to form a full cell, a half-cell, or a symmetric cell. Electrochemical cycling is performed to construct the gradient SEI layer rich in inorganic components, wherein the electrochemical cycling is either the deposition or stripping cycle of a Li—Li symmetric cell or the charge or discharge cycle of a full cell.

In some embodiments, the solid electrolyte mentioned above is assembled with lithium metal and a nickel-cobalt-manganese ternary cathode (such as NCM811 cathode) according to a full-cell assembly process. Charge-discharge cycling is conducted 3 times at a current density of 0.1 C to construct the SEI layer on the lithium metal anode.

In some embodiments, the solid electrolyte mentioned above is assembled with lithium metal according to a symmetric cell assembly process. Cycling is performed 30 times under the conditions of 0.1 mA/cm² and 0.1 mAh/cm² to construct the SEI layer on the lithium metal anode.

In some embodiments, the solid electrolyte mentioned above is assembled with lithium metal and copper metal according to a Li—Cu half-cell assembly process. Deposition is carried out for 1 hour at 0.1 mA/cm² to obtain deposited lithium metal and a lithium metal SEI layer.

In the present disclosure, the silver salt is introduced into the solid electrolyte. When matched with the lithium metal anode, the silver salt undergoes an in-situ reaction with metallic lithium to generate elemental Ag during electrochemical cycling. Meanwhile, the lithium-silver alloy and the gradient SEI layer rich in inorganic components are in-situ formed during the electrochemical cycling. The inner layer of the gradient SEI layer is rich in lithium-containing inorganic components (such as LiF), which facilitates the uniform transport of lithium ions in the SEI layer and achieves uniform lithium deposition or stripping. The outer layer of the gradient SEI layer is rich in silver-containing inorganic components (such as Ag₂S) with good ductility, which is conducive to the rapid transport of lithium ions and maintains the structural stability of the SEI layer during cycling.

Therefore, the solid electrolyte provided by the present disclosure has high ionic conductivity and stability against the lithium metal anode. Moreover, the in-situ constructed SEI layer can uniformize lithium ion deposition, inhibit lithium dendrite growth, realize stable cycling under high current, and exhibit excellent electrochemical performance at room temperature and low temperature. Furthermore, the method for preparing the solid electrolyte and the method for constructing the gradient SEI layer are simple, which is conducive to reducing production costs and realizing large-scale production.

The solid electrolyte provided by the present disclosure, when matched with a lithium metal anode, can exhibit high-current stability. The Li—Li symmetric cell with the solid electrolyte can stably cycle for more than 1700 hours under the conditions of 10 mA/cm² and 10 mAh/cm². In addition, the full cell formed by assembling the solid electrolyte with a lithium metal anode and a ternary cathode (such as NCM811) can exhibit excellent rate performance and low-temperature performance at room temperature, and can still deliver high capacity under a high rate of 10 C and a low temperature of −30° C., showing broad application prospects in the battery field. The solid electrolyte can be used to prepare high-performance, high-rate, wide-temperature-range, and high-safety solid-state batteries, and can be applied in lithium battery manufacturers, the new energy vehicle industry, consumer electronics industries such as mobile phones.

The technical solutions of the present disclosure will be illustrated in detail below with reference to examples and comparative examples.

Preparation of solid electrolytes.

### Preparation Example 1

Preparation of a PVAL composite solid electrolyte.

Step 1, 67 mg of LiFSI (lithium bis(fluorosulfonyl)imide) and 40 mg of AgNO₃ were weighted under an inert atmosphere and added into a stirring flask to obtain a first mixture. 15 mL of DMF (N, N-dimethylformamide) and 400 mg of PVDF (polyvinylidene fluoride) were added into the first mixture, and then stirred with a small stirrer at room temperature for more than 2 hours. Until AgNO₃, LiFSI, and PVDF were completely dissolved to obtain a uniform transparent solution.

Step 2, 40 mg of LLZO ceramic particles were added into the transparent solution obtained in Step 1, and then stirred at room temperature for more than 6 hours to obtain a uniform brown solution (which is a second solution).

Step 3, the second solution obtained in Step 2 was poured into a glass petri dish, and then the glass petri dish was placed in a blast drying oven at 55° C. for about 23 hours to remove the excess solvent DMF to obtain the PVAL composite solid electrolyte membrane. The PVAL composite solid electrolyte membrane was punched into an appropriate size, and store in a dry state under an inert atmosphere for later use.

### Preparation Example 2

Preparation of a PVA composite solid electrolyte.

Step 1, 267 mg of LiFSI (lithium bis(fluorosulfonyl)imide) and 15 mg of AgNO₃ were weighted under an inert atmosphere and added into a stirring flask to obtain a first mixture. 15 mL of DMF (N,N-dimethylformamide) and 400 mg of PVDF (polyvinylidene fluoride) were added into the first mixture, and then stirred with a small stirrer at room temperature for more than 2 hours. Until AgNO₃, LiFSI, and PVDF were completely dissolved to obtain a uniform transparent solution.

Step 2, the transparent solution obtained in step 1 was poured into a glass petri dish, and then the glass petri dish was placed in a blast drying oven at 55° C. for about 23 hours to remove the excess solvent DMF to obtain the PVA composite solid electrolyte membrane. The PVA composite solid electrolyte membrane was punched into an appropriate size, and store in a dry state under an inert atmosphere for later use.

### Preparation Example 3

Preparation of a PVA-LATP composite solid electrolyte.

Step 1, 267 mg of LiFSI (lithium bis(fluorosulfonyl)imide) and 15 mg of AgNO₃ were weighted under an inert atmosphere and added into a stirring flask to obtain a first mixture. 15 mL of DMF (N, N-dimethylformamide) and 400 mg of PVDF (polyvinylidene fluoride) were added into the first mixture, and then stirred with a small stirrer at room temperature for more than 2 hours. Until AgNO₃, LiFSI, and PVDF were completely dissolved to obtain a uniform transparent solution.

Step 2, 40 mg of LATP ceramic particles were added into the transparent solution obtained in step 1, and then stirred at room temperature for more than 6 hours to obtain a second solution.

Step 3, the second solution obtained in step 2 was poured into a glass petri dish, and then the glass petri dish was placed in a blast drying oven at 55° C. for about 23 hours to remove the excess solvent DMF to obtain the PVA-LATP composite solid electrolyte membrane. The PVA-LATP composite solid electrolyte membrane was punched into an appropriate size, and store in a dry state under an inert atmosphere for later use.

### Preparation Example 4

Preparation of a PVA-SiO₂ composite solid electrolyte.

Step 1, 267 mg of LiFSI (lithium bis(fluorosulfonyl)imide) and 15 mg of AgNO₃ were weighted under an inert atmosphere and added into a stirring flask to obtain a first mixture. 15 mL of DMF (N, N-dimethylformamide) and 400 mg of PVDF (polyvinylidene fluoride) were added into the first mixture, and then stirred with a small stirrer at room temperature for more than 2 hours. Until AgNO₃, LiFSI, and PVDF were completely dissolved to obtain a uniform transparent solution.

Step 2, 40 mg of SiO₂ ceramic particles were added into the transparent solution obtained in step 1, and then stirred at room temperature for more than 6 hours to obtain a second solution.

Step 3, the second solution obtained in step 2 was poured into a glass petri dish, and then the glass petri dish was placed in a blast drying oven at 55° C. for about 23 hours to remove the excess solvent DMF to obtain the PVA-SiO₂ composite solid electrolyte membrane. The PVA-SiO₂ composite solid electrolyte membrane was punched into an appropriate size, and store in a dry state under an inert atmosphere for later use.

### Comparative Preparation Example 1

Preparation of a PVL composite solid electrolyte.

Step 1, 267 mg of LiFSI (lithium bis(fluorosulfonyl)imide) was weighted under an inert atmosphere and added into a stirring flask. 15 mL of DMF (N, N-dimethylformamide) and 400 mg of PVDF (polyvinylidene fluoride) were added into the stirring flask, and then stirred with a small stirrer at room temperature for more than 2 hours. Until LiFSI and PVDF were completely dissolved to obtain a uniform transparent solution.

Step 2, 40 mg of LLZO ceramic particles were added into the transparent solution obtained in step 1, and then stirred at room temperature for more than 6 hours to obtain a uniform brown solution.

Step 3, the brown solution obtained in step 2 was poured into a glass petri dish, and then the glass petri dish was placed in a blast drying oven at 55° C. for about 23 hours to remove the excess solvent DMF to obtain the PVL solid electrolyte membrane. The PVL solid electrolyte membrane was punched into an appropriate size, and store in a dry state under an inert atmosphere for later use.

Assembling of cells.

### Example 1

Assembling cells and constructing gradient SEI layers rich in inorganic components on lithium metal anode.

Step 1, cathode slurry was prepared.

100 mg of PVDF (binder) and 1 mL of NMP (N-methylpyrrolidone) were added into a stirring flask, and stirred on a small stirrer for 1 hour until PVDF is completely dissolved to obtain a first mixture. Subsequently, 100 mg of Super P (conductive carbon black) and 1 mL of NMP were added in the first mixture and stirred at room temperature for 1 hour to obtain a second mixture. Then 800 mg of NCM811 (nickel-cobalt-manganese ternary cathode material) active substance and 1.5 mL of NMP were added into the second mixture and stirred at room temperature for more than 6 hours to obtain the cathode slurry.

Step 2, a cathode was prepared.

The cathode slurry obtained in step 1 was coated on an aluminum foil and dried at 80° C. for more than 6 hours to obtain the cathode. The cathode was cut into an appropriate size to obtain a NCM811 cathode, and the NCM811 cathode was stored in a vacuum oven for drying.

Step 3, cells were assembled.

A full cell was assembled: According to the full cell assembly process, the NCM811 cathode prepared in step 2, the PVAL composite solid electrolyte membrane prepared in Preparation Example 1, and lithium metal were assembled to obtain a PVAL full cell. The PVAL full cell was performed charge-discharge cycling 3 times at a current density of 0.1 C to construct a SEI layer on the lithium metal anode.

A symmetric cell was assembled: According to the symmetric cell assembly process, the PVAL composite solid electrolyte membrane prepared in Preparation Example 1 was sandwiched between two layers of lithium metal to assemble a PVAL/Li—Li symmetric cell. The PVAL/Li—Li symmetric cell was performed cycling 30 times under the conditions of 0.1 mA/cm² and 0.1 mAh/cm² to construct a SEI layer on the lithium metal anode.

A Li—Cu half-cell was assembled: According to the Li—Cu half-cell assembly process, the PVAL composite solid electrolyte membrane prepared in Preparation Example 1 was sandwiched between lithium metal and copper foil to assemble a PVAL/Li—Cu half-cell. The PVAL/Li—Cu half-cell was performed deposition for 1 hour at 0.1 mA/cm² to obtain deposited lithium metal and a lithium metal SEI layer.

### Comparative Example 1

Step 1, cathode slurry was prepared.

100 mg of PVDF (binder) and 1 mL of NMP (N-methylpyrrolidone) were added into a stirring flask, and stirred on a small stirrer for 1 hour until PVDF is completely dissolved to obtain a first mixture. Subsequently, 100 mg of Super P (conductive carbon black) and 1 mL of NMP were added in the first mixture and stirred at room temperature for 1 hour to obtain a second mixture. Then 800 mg of NCM811 (nickel-cobalt-manganese ternary cathode material) active substance and 1.5 mL of NMP were added into the second mixture and stirred at room temperature for more than 6 hours to obtain the cathode slurry.

Step 2, a cathode was prepared.

The cathode slurry obtained in step 1 was coated on an aluminum foil and dried at 80° C. for more than 6 hours to obtain the cathode. The cathode was cut into an appropriate size to obtain an NCM811 cathode, and the NCM811 cathode was stored in a vacuum oven for drying.

Step 3, cells were assembled.

A full cell was assembled: According to the full cell assembly process, the NCM811 cathode prepared in step 2, the PVL composite solid electrolyte membrane prepared in Comparative Preparation Example 1, and lithium metal were assembled to obtain a PVL full cell. The PVL full cell was performed charge-discharge cycling 3 times at a current density of 0.1C to construct a SEI layer on the lithium metal anode.

A symmetric cell was assembled: According to the symmetric cell assembly process, the PVL composite solid electrolyte membrane prepared in comparative Preparation Example 1 was sandwiched between two layers of lithium metal to assemble a PVL/Li—Li symmetric cell. The PVL/Li—Li symmetric cell was performed cycling 30 times under the conditions of 0.1 mA/cm² and 0.1 mAh/cm² to construct a SEI layer on the lithium metal anode.

A Li—Cu half-cell was assembled: According to the Li—Cu half-cell assembly process, the PVL composite solid electrolyte membrane prepared in comparative Preparation Example 1 was sandwiched between lithium metal and copper foil to assemble a PVL/Li—Cu half-cell. The PVL/Li—Cu half-cell was performed deposition for 1 hour at 0.1 mA/cm² to obtain deposited lithium metal and a lithium metal SEI layer.

### Example 2

Step 1, cathode slurry was prepared.

100 mg of PVDF (binder) and 1 mL of NMP (N-methylpyrrolidone) were added into a stirring flask, and stirred on a small stirrer for 1 hour until PVDF is completely dissolved to obtain a first mixture. Subsequently, 100 mg of Super P (conductive carbon black) and 1 mL of NMP were added in the first mixture and stirred at room temperature for 1 hour to obtain a second mixture. Then 800 mg of NCM811 active substance and 1.5 mL of NMP were added into the second mixture and stirred at room temperature for more than 6 hours to obtain the cathode slurry.

Step 2, a cathode was prepared.

The cathode slurry obtained in step 1 was coated on an aluminum foil and dried at 80° C. for more than 6 hours to obtain the cathode. The cathode was cut into an appropriate size to obtain an NCM811 cathode, and the NCM811 cathode was stored in a vacuum oven for drying.

Step 3, cells were assembled.

A full cell was assembled: According to the full cell assembly process, the NCM811 cathode prepared in step 2, the PVL-LATP composite solid electrolyte membrane prepared in Preparation Example 3, and lithium metal were assembled to obtain a PVL-LATP full cell.

### Example 3

Step 1, cathode slurry was prepared.

100 mg of PVDF (binder) and 1 mL of NMP (N-methylpyrrolidone) were added into a stirring flask, and stirred on a small stirrer for 1 hour until PVDF is completely dissolved to obtain a first mixture. Subsequently, 100 mg of Super P (conductive carbon black) and 1 mL of NMP were added in the first mixture and stirred at room temperature for 1 hour to obtain a second mixture. Then 800 mg of NCM811 active substance and 1.5 mL of NMP were added into the second mixture and stirred at room temperature for more than 6 hours to obtain the cathode slurry.

Step 2, a cathode was prepared.

The cathode slurry obtained in step 1 was coated on an aluminum foil and dried at 80° C. for more than 6 hours to obtain the cathode. The cathode was cut into an appropriate size to obtain an NCM811 cathode, and the NCM811 cathode was stored in a vacuum oven for drying.

Step 3, PEOA-LATP composite solid electrolyte membrane was prepared.

Step 31, 267 mg of LiTFSI and 15 mg of AgNO₃were weighted under an inert atmosphere and added into a stirring flask to obtain a first mixture. 15 mL of acetonitrile and 400 mg of PEO were added into the first mixture, and then stirred with a small stirrer at room temperature for more than 2 hours. Until AgNO₃, LiTFSI, and PEO were completely dissolved to obtain a uniform transparent solution.

Step 32, 40 mg of LATP ceramic particles were added into the transparent solution obtained in step 31, and then stirred at room temperature for more than 24 hours to obtain a second solution.

Step 33, the second solution obtained in step 32 was poured into a glass petri dish, and then the glass petri dish was placed in a blast drying oven at 60° C. for about 24 hours to remove the excess solvent acetonitrile to obtain the PEOA-LATP composite solid electrolyte membrane. The PEOA-LATP composite solid electrolyte membrane was punched into an appropriate size, and store in a dry state under an inert atmosphere for later use

Step 4, cells were assembled.

A full cell was assembled: According to the full cell assembly process, the NCM811 cathode prepared in step 2, the PEOA-LATP composite solid electrolyte membrane prepared in step 3, and lithium metal were assembled to obtain a PEOA-LATP full cell.

### Example 4

Step 1, cathode slurry was prepared.

100 mg of PVDF (binder) and 1 mL of NMP (N-methylpyrrolidone) were added into a stirring flask, and stirred on a small stirrer for 1 hour until PVDF is completely dissolved to obtain a first mixture. Subsequently, 100 mg of Super P (conductive carbon black) and 1 mL of NMP were added in the first mixture and stirred at room temperature for 1 hour to obtain a second mixture. Then 800 mg of NCM811 active substance and 1.5 mL of NMP were added into the second mixture and stirred at room temperature for more than 6 hours to obtain the cathode slurry.

Step 2, a cathode was prepared.

The cathode slurry obtained in step 1 was coated on an aluminum foil and dried at 80° C. for more than 6 hours to obtain the cathode. The cathode was cut into an appropriate size to obtain an NCM811 cathode, and the NCM811 cathode was stored in a vacuum oven for drying.

Step 3, PVDF-HFPA-LATP composite solid electrolyte membrane was prepared.

Step 31, 267 mg of LiFSI and 15 mg of AgNO₃were weighted under an inert atmosphere and added into a stirring flask to obtain a first mixture. 15 mL of DMF and 400 mg of PVDF-HFP were added into the first mixture, and then stirred with a small stirrer at room temperature for more than 2 hours. Until AgNO₃, LiFSI, and PVDF-HFP were completely dissolved to obtain a uniform transparent solution.

Step 32, 40 mg of LATP ceramic were added into the transparent solution obtained in step 31, and then stirred at room temperature for more than 24 hours to obtain a second solution.

Step 33, the second solution obtained in step 32 was poured into a glass petri dish, and then the glass petri dish was placed in a blast drying oven at 60° C. for about 24 hours to remove the excess solvent DMF to obtain the PVDF-HFPA-LATP composite solid electrolyte membrane. The PVDF-HFPA-LATP composite solid electrolyte membrane was punched into an appropriate size, and store in a dry state under an inert atmosphere for later use Step 4, cells were assembled.

A full cell was assembled: According to the full cell assembly process, the NCM811 cathode prepared in step 2, the PVDF-HFPA-LATP composite solid electrolyte membrane prepared in step 3, and lithium metal were assembled to obtain a PVDF-HFPA-LATP full cell.

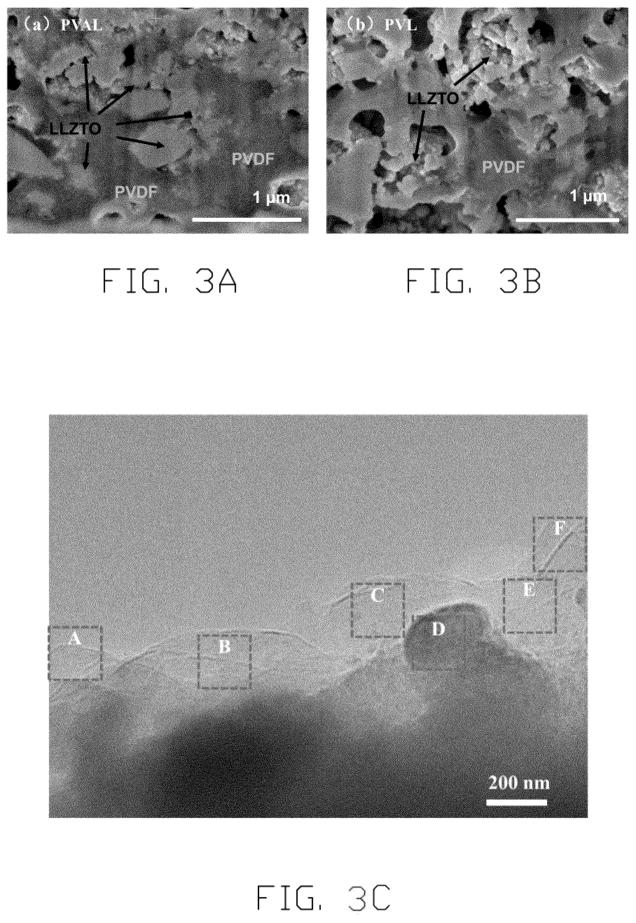

The silver salt-containing PVAL composite solid electrolyte prepared in Preparation Example 1 and the silver salt-free PVL composite solid electrolyte prepared in comparative Preparation Example 1 are taken as an Example for illustration. FIG. 3A is a cross-sectional scanning electron microscopy (SEM) image of the PVAL composite solid electrolyte. FIG. 3B is a cross-sectional SEM image of the PVL composite solid electrolyte. Referring to FIGS. 3A and 3B, the PVAL composite solid electrolyte is dense with uniformly distributed internal ceramic particles, whereas the PVL composite solid electrolyte has large internal pores and unevenly distributed ceramic particles.

In Example 1 and Comparative Example 1, Li—Cu half-cell based on the PVAL composite solid electrolyte membrane (named as PVAL/Li—Cu half-cell) and Li—Cu half-cell based on the PVL composite solid electrolyte membrane (named as PVL/Li—Cu half-cell) were assembled respectively in accordance with the Li—Cu half-cell assembly process.

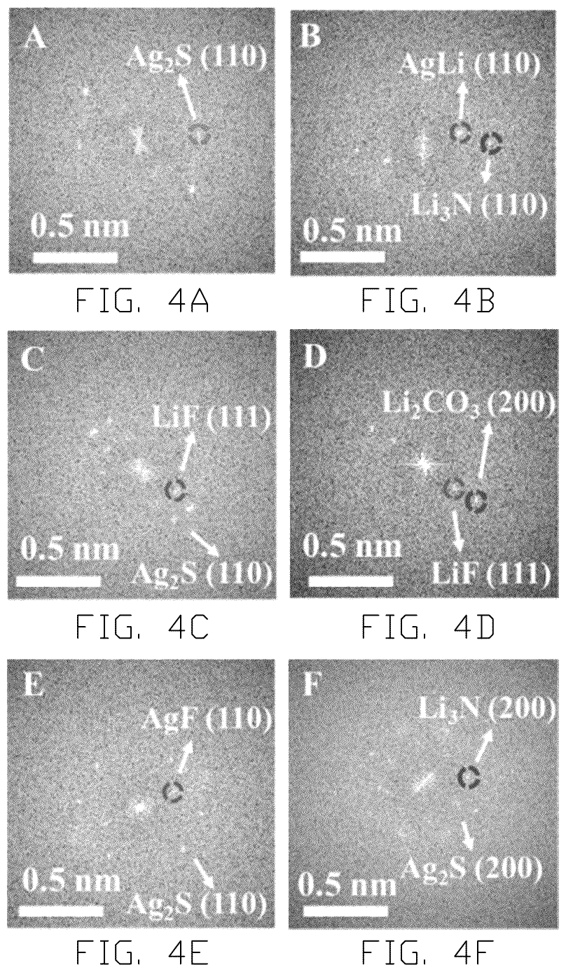

FIG. 3C is a morphological structure of a gradient SEI layer rich in inorganic components formed in the PVAL/Li—Cu half-cell in Example 1 under a cryogenic transmission electron microscope. FIGS. 4A to 4F are enlarged views of Parts A to F in FIG. 3C, respectively. FIG. 5 is a morphological structure of the gradient SEI layer shown in FIG. 3C with silver-containing inorganic salts and lithium-containing inorganic salts labeled. Defining a side adjacent to the lithium metal anode as the inner layer and a side away from the lithium metal anode as the outer layer. Referring to FIGS. 3C-5, it can be found that the inner layer of the gradient SEI layer rich in inorganic components is mainly composed of inorganic components such as LiF, which facilitates the uniform transport of lithium ions in the gradient SEI layer and achieves uniform lithium deposition or stripping. Referring to FIGS. 3C-5, it can also be found that the outer layer is composed of inorganic components with good ductility such as Ag₂S, which is conducive to the rapid transport of lithium ions and maintains the structural stability of the gradient SEI layer during cycling.

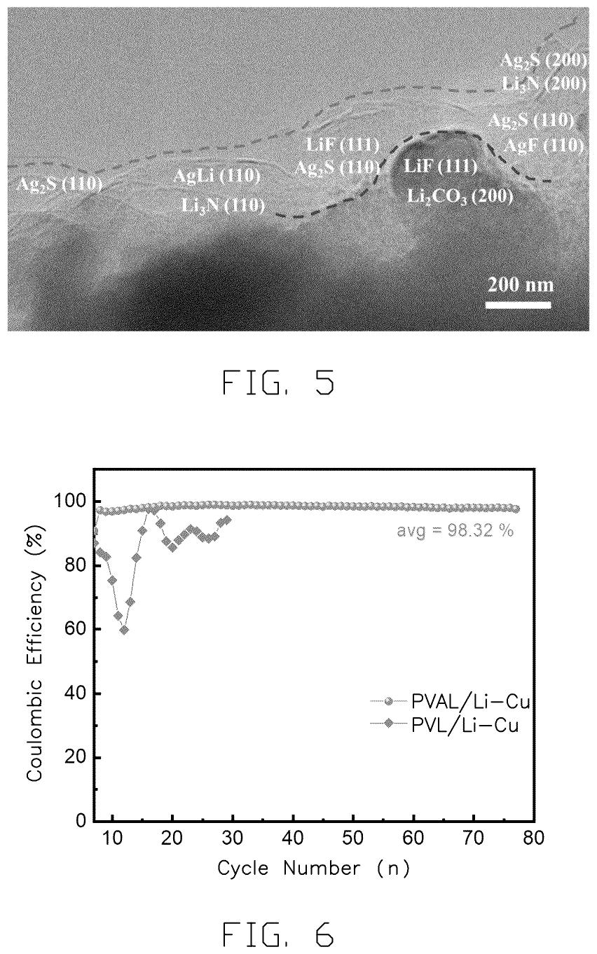

Referring to FIG. 6, which shows coulombic efficiency test curves of the PVAL/Li—Cu half-cell in Example 1 and the PVL/Li—Cu half-cell in Comparative Example 1. The results show that the Li—Cu half-cell based on the PVAL composite solid electrolyte membrane in Example 1 cycled 80 times under the conditions of 0.5 mA/cm² and 1 mAh/cm², with an average coulombic efficiency of 98.3%, which is far higher than that of the Li—Cu half-cell based on the PVAL composite solid electrolyte membrane in Comparative Example 1. This indicates that during cycling, the PVAL composite solid electrolyte containing silver salt and lithium salt can effectively construct a stable gradient SEI layer rich in inorganic components together with lithium metal. Thus, the stability (especially the stability under high current) of the electrolyte against lithium metal can be improved, and high-flux operation can be realized.

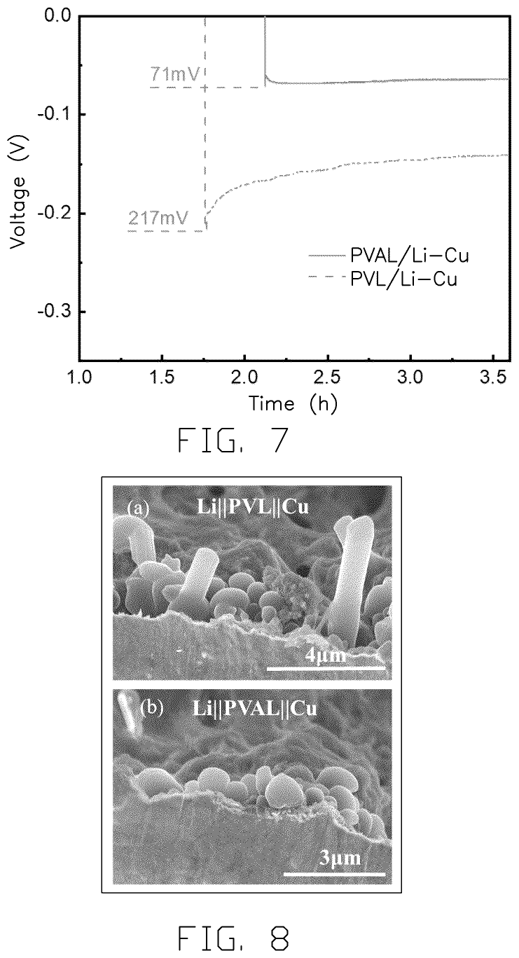

Referring to FIG. 7, which shows the nucleation potential test curves of the PVAL/Li—Cu half-cell in Example 1 and the PVL/Li—Cu half-cell in Comparative Example 1. The results show that the nucleation overpotential of the Li—Cu half-cell based on the PVAL composite solid electrolyte membrane in Example 1 was 71 mV at 0.5 mA/cm², which is much lower than the 217 mV of the Li—Cu half-cell based on the PVL composite solid electrolyte membrane in Comparative Example 1. This indicates that during cycling, the PVAL solid electrolyte containing silver salt and lithium salt can effectively construct a stable gradient SEI layer rich in inorganic components together with lithium metal, which can effectively reduce the formation of lithium dendrites.

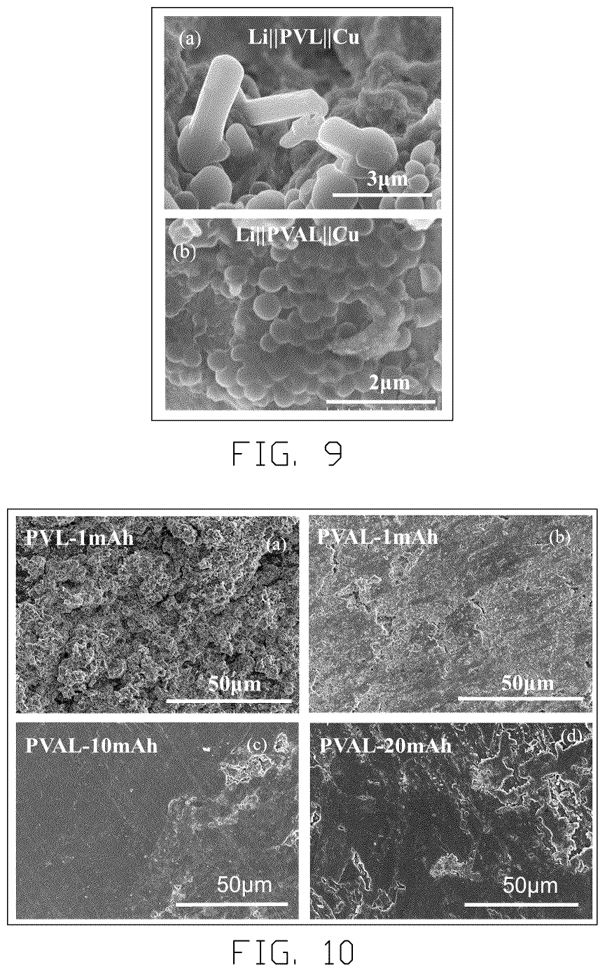

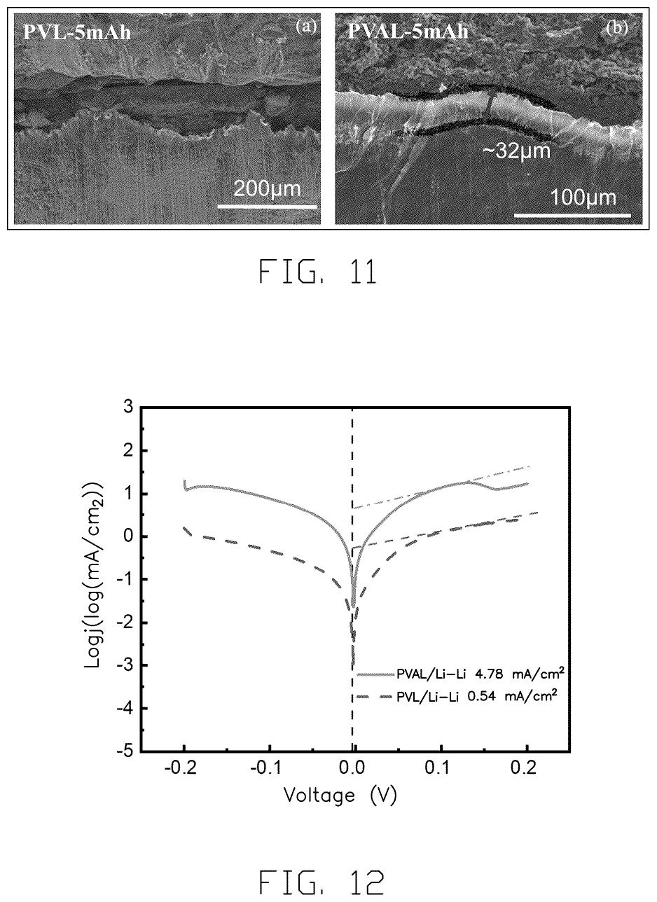

Referring to FIG. 8, which shows cross-sectional SEM images of nucleation of the PVL/Li—Cu half-cell in Comparative Example 1 and nucleation of the PVAL/Li—Cu half-cell in Example 1, respectively. Referring to FIG. 9, which shows surface SEM images of nucleation of the PVL/Li—Cu half-cell in Comparative Example 1 and nucleation of the PVAL/Li—Cu half-cell in Example 1, respectively. It can be seen that the lithium metal nucleation morphology of the Li—Cu half-cell based on the PVAL composite solid electrolyte membrane was fine spherical particles at 0.5 mA/cm², while the lithium metal nucleation morphology of the Li—Cu half-cell based on the PVL composite solid electrolyte membrane had many dendritic crystals at 0.5 mA/cm².

In Example 1 and Comparative Example 1, Li—Li symmetric cell based on the PVAL composite solid electrolyte membrane (named as PVAL/Li—Li symmetric cell) and Li—Li symmetric cell based on the PVL composite solid electrolyte membrane (named as PVL/Li—Li symmetric cell) were assembled respectively in accordance with the Li—Li symmetric cell assembly process.

Referring to FIG. 10, which shows a surface SEM image of lithium metal deposition after depositing 1 mAh at 0.5 mA/cm² for the PVL/Li—Li symmetric cell) in Comparative Example 1, and surface SEM images of lithium metal deposition after depositing 1 mAh, 10 mAh, and 20 mAh at 0.5 mA/cm² respectively for the PVAL/Li—Li symmetric cell in Example 1. It can be seen that compared with Comparative Example 1, the Li—Li symmetric cell based on the PVAL composite solid electrolyte membrane exhibited a more uniform and flat lithium deposition morphology. In particular, when the battery capacity increased to 20 mAh, the battery still maintained a uniform and flat lithium deposition morphology.

Referring to FIG. 11, which shows cross-sectional SEM images of lithium metal deposition after depositing 5 mAh at 0.5 mA/cm² for the PVL/Li—Li symmetric cell in Comparative Example 1 and the PVAL/Li—Li symmetric cell in Example 1, respectively. It can be seen that compared with Comparative Example 1, the Li—Li symmetric cell based on the PVAL composite solid electrolyte membrane in Example 1 exhibited a more uniform and dense lithium deposition cross-sectional morphology.

Referring to FIG. 12, which shows exchange current density test curves of the PVAL/Li—Li symmetric cell of Example 1 and the PVL/Li—Li symmetric cell in Comparative Example 1. The results show that compared with Comparative Example 1, the Li—Li symmetric cell based on the PVAL composite solid electrolyte membrane in Example 1 exhibited a higher exchange current density and better electrode reversibility.

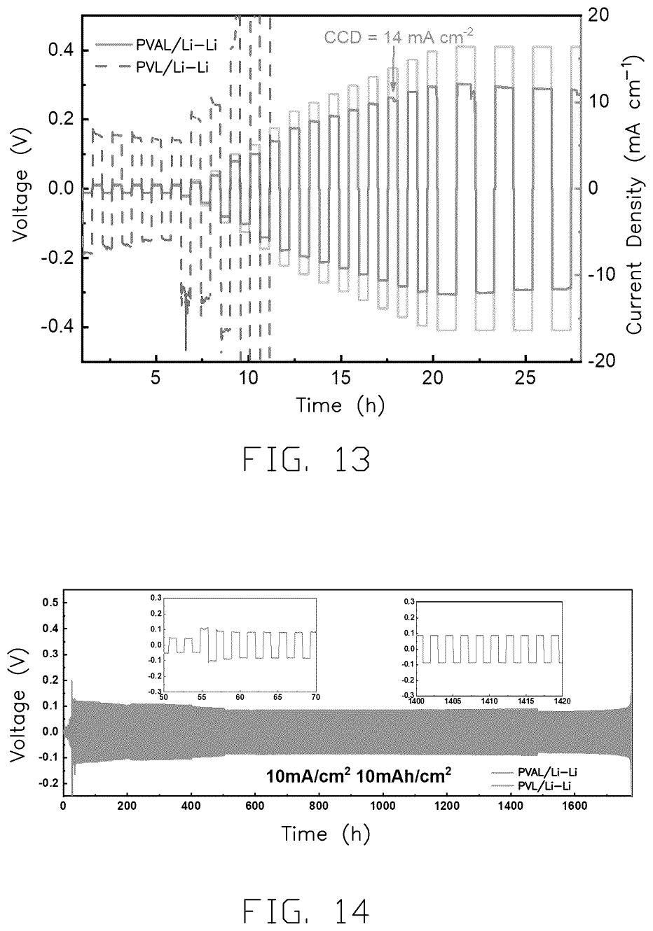

Referring to FIG. 13, which shows critical current density (CCD) test curves of the PVAL/Li—Li symmetric cell of Example 1 and the PVL/Li—Li symmetric cell in Comparative Example 1. The results show that compared with Comparative Example 1, the Li—Li symmetric cell based on the PVAL composite solid electrolyte membrane in Example 1 exhibited a higher critical current density.

Referring to FIG. 14, which shows long-cycle test curves of the PVAL/Li—Li symmetric cell of Example 1 and the PVL/Li—Li symmetric cell in Comparative Example 1 under 10 mA/cm² and 10 mAh/cm², respectively. The results show that compared with Comparative Example 1, the Li—Li symmetric cell based on the PVAL composite solid electrolyte membrane in Example 1 exhibited excellent lithium metal stability, enabling stable cycling for more than 1700 hours, which is far beyond the level reported in existing literature. In contrast, the battery based on the PVL composite solid electrolyte membrane in Comparative Example 1 short-circuited quickly.

Referring to FIG. 15, which shows impedance test curves of the PVAL/Li—Li symmetric cell in Example 1 before and after 675 hours of cycling, respectively. The results show that the Li—Li symmetric cell based on the PVAL composite solid electrolyte membrane in Example 1 exhibited low impedance and excellent stability against lithium metal.

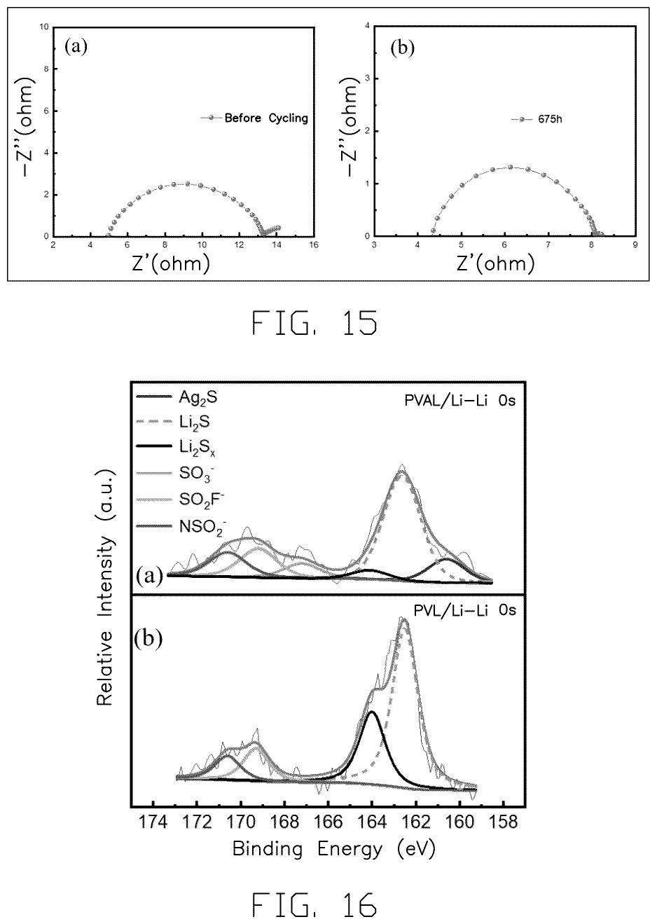

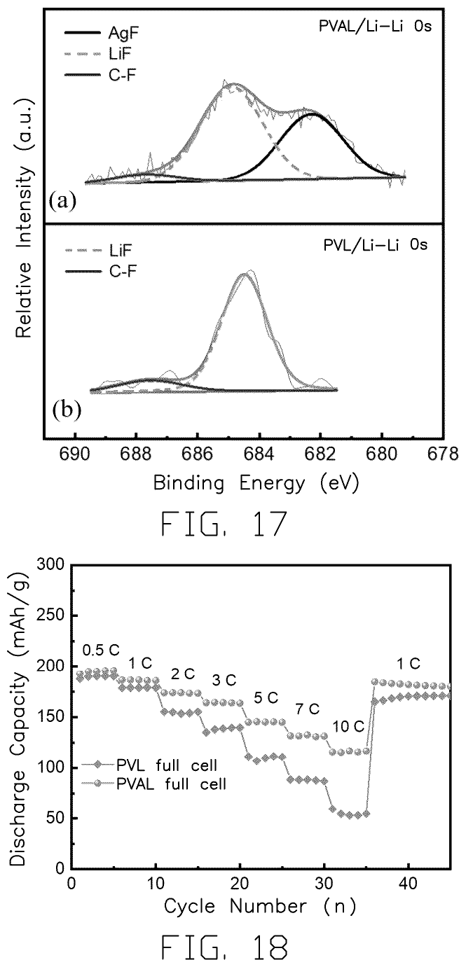

Referring to FIG. 16, which shows XPS test curves of S2p on the lithium metal surface after cycling for the PVAL/Li—Li symmetric cell in Example 1 and the PVL/Li—Li symmetric cell in Comparative Example 1, respectively. Referring to FIG. 17, which shows XPS test curves of F1s on the lithium metal surface after cycling for the PVAL/Li—Li symmetric cell in Example 1 and the PVL/Li—Li symmetric cell in Comparative Example 1, respectively. The results show that silver-containing inorganic components such as Ag₂S and AgF were present on the lithium metal surface of the Li—Li symmetric cell based on the PVAL composite solid electrolyte membrane in Example 1 after cycling.

In Example 1 and Comparative Example 1, full cell based on the PVAL composite solid electrolyte membrane and full cell based on the PVL composite solid electrolyte membrane were assembled respectively in accordance with the full-cell assembly process.

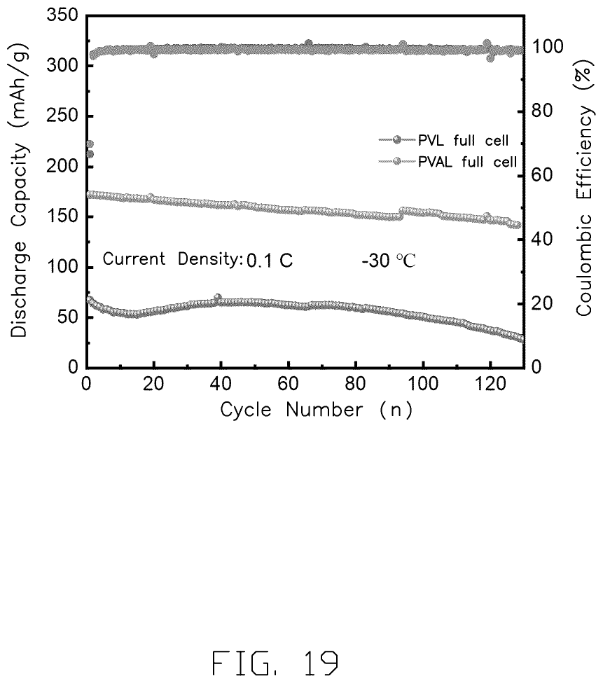

Referring to FIG. 18, which shows rate performance test curves of a full cell based on the PVAL composite solid electrolyte membrane (named as PVAL full cell) in Example 1 and a full cell based on the PVL composite solid electrolyte membrane (named as PVL full cell) in Comparative Example 1. It can be seen that the full cell assembled by matching the PVAL composite solid electrolyte membrane with the NCM811 cathode and lithium metal anode in Example 1 still delivered a capacity of 115 mAh/g at a current density of 10 C at room temperature.

Referring to FIG. 19, which shows cycle performance test curves of the PVAL full cell in Example 1 and the PVL full cell in Comparative Example 1 at a low temperature of −20° C., respectively. The results show that compared with Comparative Example 1, the full cell assembled by matching the PVAL composite solid electrolyte membrane with the NCM811 cathode and lithium metal anode in Example 1 exhibited higher discharge capacity and stability at −30° C. under a current density of 0.1 C.

The above results indicate that the composite solid electrolyte provided in the present disclosure can in-situ generate a gradient SEI layer containing silver-containing inorganic components during electrochemical cycling. The inner layer of the gradient SEI layer rich in inorganic components is mainly composed of inorganic components such as LiF, which facilitates the uniform transport of lithium ions in the SEI layer and achieves uniform lithium deposition or stripping. The outer layer of the gradient SEI layer rich in inorganic components is composed of inorganic components with good ductility such as Ag₂S, which is conducive to the rapid transport of lithium ions and maintains the structural stability of the SEI layer during cycling. Furthermore, the composite solid electrolyte based on the gradient SEI layer rich in inorganic components exhibited high-current stability when matched with a lithium metal anode. The PVAL/Li—Li symmetric cell could stably cycle for more than 1700 hours under the conditions of 10 mA/cm² and 10 mAh/cm². In addition, the full cell assembled by matching the composite solid electrolyte provided in the present disclosure with a lithium metal anode and an NCM811 cathode exhibited excellent rate and low-temperature performance at room temperature, and still delivered high capacity at a high rate of 10 C and a low temperature of −30° C., thus showing broad application prospects in the battery field.

It is to be understood, even though information and advantages of the present embodiments have been set forth in the foregoing description, together with details of the structures and functions of the present embodiments, the disclosure is illustrative only; changes may be made in detail, especially in matters of shape, size, and arrangement of parts within the principles of the present embodiments to the full extent indicated by the plain meaning of the terms in which the appended claims are expressed.

What is claimed is:

1. A solid electrolyte, comprising: a polymer, a silver salt, and an alkali metal salt.

2. The solid electrolyte of claim 1, wherein the silver salt comprises at least one of AgNO₃, AgTFSI, and AgClO₃.

3. The solid electrolyte of claim 1, wherein based on a mass of the solid electrolyte, a content of the silver salt is 1.5 wt. %˜10 wt. %.

4. The solid electrolyte of claim 1, wherein the alkali metal salt is a sulfur-containing alkali metal salt.

5. The solid electrolyte of claim 4, wherein the sulfur-containing alkali metal salt comprises at least one of lithium bis(fluorosulfonyl)imide and lithium bis(trifluoromethanesulfonyl)imide.

6. The solid electrolyte of claim 1, further comprising a plurality of ceramic particles, wherein the plurality of ceramic particles comprises at least one of Li₇La₃Zr₂O₁₂ ceramic particles, Li_{1.3}Al_{0.3}Ti_{1.7}(PO₄)₃ ceramic particles, SiO₂ ceramic particles, and Al₂O₃ceramic particles.

7. The solid electrolyte of claim 1, wherein the polymer comprises at least one of polyethylene oxide, polyvinylidene fluoride, and polyvinylidene fluoride-hexafluoropropylene.

8. A battery, comprising:
a metal electrode; and
a solid electrolyte in physical contact with the metal electrode, wherein the solid electrolyte comprises a polymer, a silver salt, and an alkali metal salt, and
a solid electrolyte interphase (SEI) layer formed on a surface of the solid electrolyte contacting the metal electrode.

9. The battery of claim 8, wherein the silver salt comprises at least one of AgNO₃, AgTFSI, and AgClO₃.

10. The battery of claim 8, wherein based on a mass of the solid electrolyte, a content of the silver salt is 1.5 wt. %˜10 wt. %.

11. The battery of claim 8, wherein the alkali metal salt is a sulfur-containing alkali metal salt, the sulfur-containing alkali metal salt comprises at least one of lithium bis(fluorosulfonyl)imide and lithium bis(trifluoromethanesulfonyl)imide.

12. The battery of claim 8, wherein the solid electrolyte further comprises a plurality of ceramic particles, the plurality of ceramic particles comprises at least one of Li₇La₃Zr₂O₁₂ ceramic particles, Li_{1.3}Al_{0.3}Ti_{1.7}(PO₄)₃ ceramic particles, SiO₂ ceramic particles, and Al₂O₃ceramic particles.

13. The battery of claim 8, wherein the polymer comprises at least one of polyethylene oxide, polyvinylidene fluoride, and polyvinylidene fluoride-hexafluoropropylene.

14. The battery of claim 8, wherein the SEI layer comprises alkali metal-containing inorganic salts and silver-containing inorganic salts.

15. The battery of claim 14, wherein a side of the SEI layer adjacent to the alkali metal is an inner layer, and a side away from the alkali metal is an outer layer;
in the SEI layer, a content of the alkali metal-containing inorganic salts decreases from the inner layer to the outer layer, while a content of the silver-containing inorganic salts increases from the inner layer to the outer layer.

16. The battery of claim 14, wherein the alkali metal is metallic lithium, the alkali metal-containing inorganic salts comprise at least one of LiF, Li₃N, and Li₂S;
the silver-containing inorganic salts comprise at least one of Ag₂S and AgF.

17. A method for manufacturing a solid electrolyte, comprising:
mixing a polymer, a silver salt, and a lithium salt to obtain a mixed solution; and
drying the mixed solution to obtain the solid electrolyte.

18. The method of claim 17, wherein the silver salt comprises at least one of AgNO₃, AgTFSI, and AgClO₃.

19. The method of claim 18, wherein the lithium salt comprises at least one of lithium bis(fluorosulfonyl)imide and lithium bis(trifluoromethanesulfonyl)imide.

20. The method of claim 17, wherein the mixed solution further comprises a plurality of ceramic particles, the plurality of ceramic particles comprises at least one of Li₇La₃Zr₂O₁₂ ceramic particles, Li_{1.3}Al_{0.3}Ti_{1.7}(PO₄)₃ ceramic particles, SiO₂ceramic particles, and Al₂O₃ceramic particles.
